(19) United States
(12) Patent Application Publication
(10) Pub. No.: US 2021/0014952 A1
(43) Pub. Date: Jan. 14, 2021

(54) SYSTEM AND METHOD FOR AUTOMATED LIGHT LEVEL AND DAYLIGHT HARVESTING CALIBRATION USING MOBILE HANDHELD DEVICES

(71) Applicants: Aaron ARD, Ponchatoula, LA (US); Thomas LEONARD, Tualatin, OR (US)

(72) Inventors: Aaron ARD, Ponchatoula, LA (US); Thomas LEONARD, Tualatin, OR (US)

(73) Assignee: LEVITON MANUFACTURING CO., INC., Melville, NY (US)

(21) Appl. No.: 16/308,291

(22) PCT Filed: Jun. 9, 2017
(86) PCT No.: PCT/US2017/366888

§ 371 Date: Dec. 7, 2018

Related U.S. Application Data
(60) Provisional application No. 62/352,215, filed on Jun. 20, 2016.

(51) Int. Cl. H05B 47/11; G08C 17/02; H05B 47/19; H05B 45/10

(52) U.S. Cl. CPC H05B 47/11; H05B 45/10; H05B 47/19; G08C 17/02

(57) ABSTRACT

A calibration and daylighting control system provides a predetermined lighting level at a work surface. The system preferably includes a light sensor and a load control device for controlling a connected lighting element to provide light to the associated area and a work surface located therein. A wireless transceiver can provide wireless communication with a portable remote device such as a smart phone. A processor can be coupled to the light sensor, load control device and transceiver. The processor may be programmed to receive, via the transceiver, wireless signals from the portable remote device when the remote device is positioned on the work surface, and set a daylighting level of the light sensor based on the wireless signals. The wireless signals can be indicative that the daylighting level of the light sensor corresponds within a predetermined amount to the user-selected lighting level at the work surface.

### CROSS-REFERENCE TO RELATED APPLICATIONS

This application is a non-provisional of pending U.S. Provisional Patent Application Ser. No. 62/352,215, filed Jun. 20, 2016, titled “System and Method for Automated Light Level and Daylight Harvesting Calibration Using Mobile Handheld Devices”, the entirety of which application is incorporated by reference herein.

### FIELD OF THE DISCLOSURE

The present disclosure relates generally to lighting systems, and more particularly to an improved system and method for calibrating a lighting system using a mobile handheld device.

### BACKGROUND OF THE DISCLOSURE

Daylight harvesting is a lighting strategy designed to reduce excessive internal light levels during peak consumption hours, where external light sources such as sunlight substitute for interior electrical lighting. Lighting systems are typically sized to provide a minimum light level under the assumption that no other light sources are available in the space. Yet, during varying times of the day, other sources of light, such as sunlight, may illuminate the interior space such that the total amount of light exceeds the minimum required level, resulting in a waste of energy. For example, during midday, excess electrical lighting may be minimized and bright sunlight can be utilized to provide up to 100% of the required illumination, when energy costs are highest.

Daylight harvesting systems can also be used to provide a constant level of light on work surfaces to avoid moments when the external light sources provide an excessive amount of light, potentially resulting in periods of glare and wasted energy. Alternatively, when light levels are low (i.e. when clouds roll in or nighttime falls), daylight harvesting systems can maintain a constant level of light by continuously increasing and decreasing the amount of light supplied by the internal electrical lighting.

In office settings, it can be desirable to provide a work surface, such as a desktop, with a consistent minimum level of light. Light sensors, such as photocells, can be used to precisely monitor light levels, and when used as part of an energy management system, light sensors can work with other system components to automatically adjust light levels to a user defined level (e.g., a minimum level required for a particular task to be performed in the affected area). In some systems, the light sensor measures the amount of light in a specific area and sends this data to a lighting controller (e.g., dimmer, relay, lighting control system, etc.) which, in turn, adjusts lighting fixtures to provide a constant lighting level in the affected area. Thus, the lights in a room may automatically brighten or dim depending on how much light the light sensor detects, with the result being an overall energy savings.

Although such systems can reduce overall energy usage, they may not provide a constant desired level of lighting at a work surface. This is because light sensors are typically mounted in or on the ceiling pointing downward, at some distance away from the work surface. Maintaining a constant light level on the work surface can be difficult because a change in the light sensor signal at the ceiling may not cause the same change in illuminance at the work surface.

In view of the foregoing, it would be advantageous to provide a system and method for calibrating a lighting system employing a daylighting scheme so that a constant light level can be achieved at a work surface.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Disclosed herein is an improved calibration and daylighting control system for providing a predetermined lighting level at a work surface. The system may include a light sensor for detecting a light level in an associated area; a lighting element for providing an amount of light to the associated area and the work surface located within the associated area; a load control device for controlling the amount of light provided by the lighting element; a wireless transceiver for wireless communication with a portable remote device; and a processor coupled to the light sensor, the load control device and the wireless transceiver. The processor may be programmed to: (i) receive, via the wireless transceiver, wireless signals from the portable remote device; and (ii) set a daylighting level of the light sensor based on the received wireless signals; wherein the received wireless signals are indicative that the daylighting level of the light sensor corresponds within a predetermined amount to a user-selected lighting level at the work surface.

The processor may be programmed to adjust the amount of light provided by the lighting element based on the user-selected lighting level and a light level sensed by the light sensor. The processor may be programmed to increase the amount of light provided by the lighting element when the received wireless signals indicate that a light level sensed by the portable remote device at the work surface is lower than the user-selected lighting level by more than a predetermined amount. The processor may be programmed to decrease the amount of light provided by the lighting element when the received wireless signals indicate that a light level sensed by the portable remote device at the work surface is greater than the user-selected lighting level by more than a predetermined amount.

The portable remote device may be one of a smartphone, a smart tablet or a laptop. The user selected lighting level may be inputted to the portable remote device via an application executable on the portable remote device. The portable remote device may include a processor, a display, and an application executable on the portable remote device. The user-selected lighting level may be selectable via the application.

In use, after the daylighting level of the light sensor is set, the processor may be programmed to adjust the amount of light provided by the lighting element so that a lighting level sensed by the light sensor deviates from the set daylighting level by less than a predetermined amount. Adjusting the amount of light provided by the lighting element so that a lighting level sensed by the light sensor deviates from the set daylighting level by less than a predetermined amount may result in the lighting level at the work surface deviating from the user-selected lighting level by less than the predetermined amount.

The present disclosure may also be directed to a method for calibrating and controlling a lighting system to provide a predetermined lighting level at a work surface. The method may include executing an application on a portable remote device. The application may cause the portable remote device to: receive a user input identifying a user-selected light level value; obtain a sensed light level value from a light sensor of the portable remote device; comparing the user-selected light level value to the sensed light level value; and sending a wireless signal to a lighting controller; and receiving, at the lighting controller, the wireless signal from the portable remote device. The wireless signal may include information representative of the comparison of the user-selected light level value to the sensed light level value.

In use, if the information representative of the comparison indicates that the sensed light level value is different from the user-selected light level value by more than a predetermined amount, the lighting controller may adjust an amount of light provided by a lighting element providing light to the work surface. For example, when the information representative of the comparison indicates that the sensed light level value is less than the user-selected light level value by more than the predetermined amount, the lighting controller may increase the amount of light provided by the lighting element by an incremental amount. Wherein when the information representative of the comparison indicates that the sensed light level value is greater than the user-selected light level value by more than the predetermined amount, the lighting controller may decrease the amount of light provided by the lighting element by an incremental amount.

In one embodiment, after the lighting controller adjusts the amount of light provided by the lighting element, the portable remote device may compare a new sensed light level value to the user-selected light level and send a new wireless signal to the lighting controller, the new wireless signal including information representative of the comparison of the user-selected light level value to the new sensed light level. In use, if the information representative of the comparison indicates that the sensed light level value is different from the user-selected light level value by less than the predetermined amount, the lighting controller may set a daylighting level of a light sensor of the lighting system.

In one embodiment, the method may control the amount of light provided by the lighting element so that the lighting level sensed by the light sensor deviates from the set daylighting level by less than the predetermined amount. Controlling the amount of light provided by the lighting element may result in the lighting level at the work surface deviating from the user-selected lighting level by less than the predetermined amount.

The portable remote device may be one of a smartphone, a smart tablet or a laptop. The wireless signal may be a protocol selected from the list consisting of Wi-Fi, Bluetooth, ZigBee, near field communication and Z-wave.

The present disclosure may also be directed to a lighting control system. The system may include a light sensor; a load control device for controlling an amount of light provided by a connected lighting element, the connected lighting element for providing light to the associated area and a work surface located within the associated area; a wireless transceiver for wireless communication with a portable remote device; and a processor coupled to the light sensor and the wireless transceiver. The light sensor, the load control device, the wireless transceiver and the processor may be provided within a housing. The processor may be programmed to: receive, via the wireless transceiver, wireless signals from the portable remote device; and calibrate a daylighting level of the light sensor based on the received signals. The received signals may be representative of a user-selected lighting level at the work surface, and the daylighting level of the light sensor may be calibrated to the user-selected lighting level at the work surface. The processor may be further programmed to (i) increase the amount of light provided by the lighting element when the received wireless signals indicate that a light level sensed by the portable remote device at the work surface is lower than the user-selected lighting level by more than a predetermined amount and (ii) decrease the amount of light provided by the lighting element when the received wireless signals indicate that a light level sensed by the portable remote device at the work surface is greater than the user-selected lighting level by more than a predetermined amount.

The present disclosure may also be directed to a method for calibrating and controlling a lighting system to provide a predetermined lighting level at a work surface. The method may include executing an application on a portable remote device. The application may cause the portable remote device to: receive a user input identifying a user-selected light level value; obtain a sensed light level value from a light sensor of the portable remote device at the work surface; compare the user-selected light level value to the sensed light level value; and send a wireless signal to a lighting controller. The wireless signal from the portable remote device may be received at the lighting controller. The wireless signal from the portable remote device may indicate (i) that the sensed light level value at the work surface is different from the user-selected light level value by more than a predetermined amount and, in response thereto, the lighting controller selectively adjusts an amount of light provided by a lighting element, or (ii) that the sensed light level value at the work surface is different from the user-selected light level value by less than a predetermined amount and, in response thereto, the lighting controller obtains a lighting level from a light sensor associated with the lighting system and sets a daylighting level for the light system.

### BRIEF DESCRIPTION OF THE DRAWINGS

FIG. 1 is a schematic diagram of an exemplary lighting control arrangement according to the disclosure;

FIG. 2 is a schematic diagram of an exemplary lighting control system according to a first embodiment of the disclosure;

FIG. 3 is a schematic diagram of a lighting controller portion of the system of FIG. 2;

FIG. 4 is a schematic diagram of an exemplary lighting control system according to a second embodiment of the disclosure;

FIG. 5 is a schematic diagram of a lighting controller portion of the system of FIG. 4; and

FIG. 6 is a flow diagram illustrating an exemplary embodiment of a method for implementing a system in accordance with the present disclosure.

### DETAILED DESCRIPTION

The present disclosure relates to a system and method for calibrating a lighting system and for controlling one or more lighting elements to provide a desired lighting level at a work surface regardless of the amount of natural light present at the work surface. The system and method may include aspects that allow a light sensor to be calibrated so that a daylighting set level of the light sensor corresponds to a desired light level at a work surface. In some embodiments, the system and method include the use of a portable remote device, such as a smartphone, smart tablet, laptop or the like to obtain a light level reading at the work surface, and to calibrate the daylighting set level of the light sensor accordingly. This calibration can include automatically adjusting an amount of light provided by a lighting element in the room to achieve the desired light level at the work surface. In some embodiments, the calibration technique can employ a custom application “App” loaded on the portable remote device. The App may enable the portable remote device to communicate with aspects of the lighting system to adjust the amount of light provided by the lighting element up or down to obtain the calibrated daylighting level for the light sensor.

Once the daylighting level for the light sensor is established, the lighting element can be controlled in a manner that ensures that the combined light from the lighting element and natural light sources (e.g., sunlight) provides a substantially constant light level at the work surface.

The system and method of the present disclosure will now be described more fully with reference to the accompanying drawings, in which preferred embodiments of the system and method are presented. The system and method may, however, be embodied in many different forms and should not be construed as being limited to the embodiments set forth herein. Rather, these embodiments are provided so that this disclosure will be thorough and complete, and will fully convey the scope of the disclosed system and method to those skilled in the art. In the drawings, like numbers refer to like elements throughout unless otherwise noted.

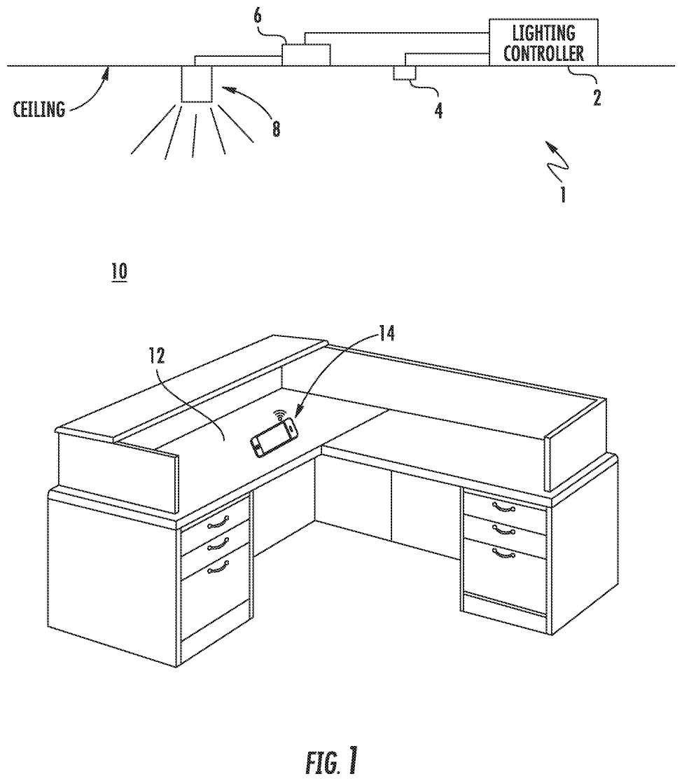

FIG. 1 shows an exemplary lighting control system 1 which may include a lighting controller 2 coupled to a light sensor 4, a load control device 6 and a lighting element 8. In the illustrated embodiment, the components of the lighting control system 1 are positioned in or at the ceiling level, but it will be appreciated that this is not critical and that one or more components can be positioned at different locations within the associated room. In addition, though the elements of the lighting control system 1 are shown as being individual distinct components, it will be appreciated that some or all of the components may be combined with each other to create multi-component units. Although not shown, one or more of the lighting controller 2, load control device 6 and/or lighting element 8 may further be coupled to a source of line power.

As will be understood, the lighting controller 2 may receive inputs and, based on the inputs received, control the load control device 6 to turn the lighting element 8 on and off and/or to dim the lighting element up or down. For example, the lighting controller 2 may be coupled to the light sensor 4 to receive signals representative of a light level sensed by the light sensor 4. In some embodiments, the lighting controller 2 may use this information to monitor the ambient light level in an associated room 10 and to adjust the amount of light provided by the lighting element 8 to maintain a substantially constant lighting level in the room 10 and/or on a work surface 12 disposed within the room 10.

As will be described in greater detail later, the lighting controller 2 may be implemented as a standalone unit, or it may be incorporated into an occupancy sensor, an entry station, a wall switch or other lighting control device. As such, the lighting controller 2 may be coupled to or in the form of an occupancy sensor to receive signals representative of an occupancy detection in the room 10 and/or a wall switch or entry station to receive direct instructions from an occupant. The lighting controller 2 may use this information to adjust the amount of light provided by the lighting element 8. In addition, the lighting controller 2 may have the capability of wirelessly communicating with a portable remote device 14 via one or more wireless communication protocols. The lighting controller 2 may be coupled to other elements of the lighting control system 1 as well so that the lighting controller 2 can adjust the amount of light provided by the lighting element 8. In some cases, the lighting controller 2 may adjust the amount of light provided by the lighting element 8 based on the wireless communications with the portable remote device (e.g., during calibration of the system), while in other cases the lighting controller 2 may adjust the amount of light provided by the lighting element 8 based on information received from the light sensor 4, occupancy sensor and/or wall switch/entry station (e.g., during normal operation).

In some embodiments, the lighting controller 2 includes logic, either hardwired or in the form of a microcontroller, for receiving information from the light sensor 4 and for controlling the amount of light provided by the lighting element 8 depending on an ambient light level sensed by the light sensor 4.

The load control device 6 may be a power pack configured as a standalone unit, or it may be a relay disposed within an occupancy sensor housing for turning power on/off or sending a 0-10V signal to a light emitting diode (LED) drive to dim up/down the lighting element 8. The lighting element 8 may, in some embodiments, be one or more LEDs. The light sensor 4 may be a photocell or other appropriate light sensor. The portable remote device 14 may be a smartphone, smart tablet, laptop or the like.

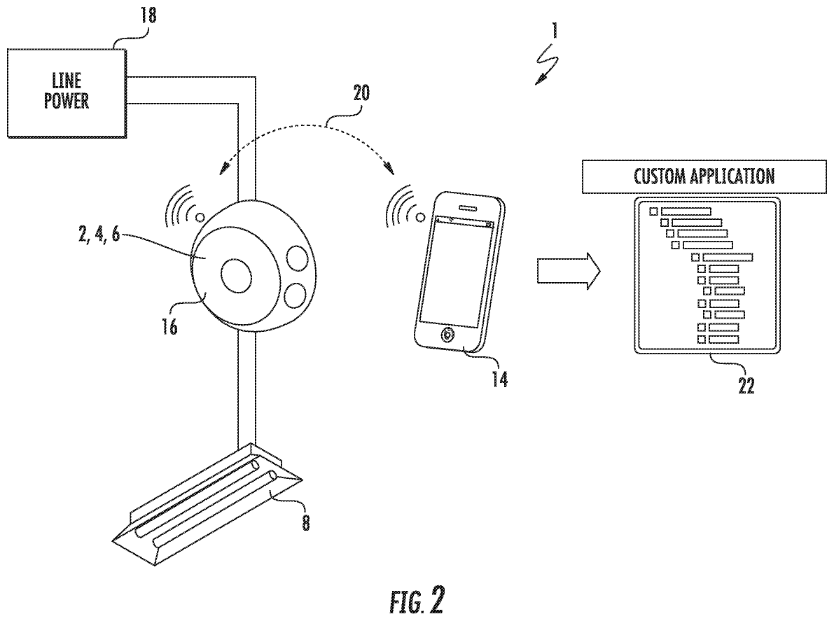

FIG. 2 shows an embodiment of a lighting control system 1 including an occupancy sensor 16. The occupancy sensor 16 preferably includes, within its housing, the lighting controller 2, the light sensor 4 and the load control device 6. The occupancy sensor 16 preferably also includes a wireless transceiver for communicating with the portable remote device 14. In the illustrated embodiment, the occupancy sensor 16 is a line voltage occupancy sensor that receives power from a source of line power 18 and controls the lighting element 8 in response to a sensed occupancy condition in a monitored space. In the illustrated embodiment, the load control device 6 comprises an integral relay for providing power to the lighting device 8. As will be appreciated, the relay may be coupled to the lighting element 8 and may also be coupled to the source of line power 18 so that the lighting element 8 may be selectively illuminated. For example, the lighting element 8 may be selectively illuminated in response to an occupancy condition sensed by the occupancy sensor 16 or a command from the lighting controller 2. The load control device 6 may provide relay switched power for turning the lighting element 8 ON and OFF, along with 1-10 Vdc dimmer control for dimming the load 4 UP and DOWN.

As will be described, the lighting controller 2 may be configured to receive wireless signals 20 from the portable remote device 14 to perform one or more operations. For example, a user can employ the portable remote device 14 to calibrate a daylighting level of the light sensor 4, as will be described in greater detail below. In some embodiments, the portable remote device 14 may call a custom application 22 that includes an appropriate interface for enabling a user to calibrate the daylighting level of the light sensor 4 to provide a desired light level at a work surface 12. In non-limiting exemplary embodiments, the portable remote device 14 may be a smartphone, smart tablet, laptop, and the like.

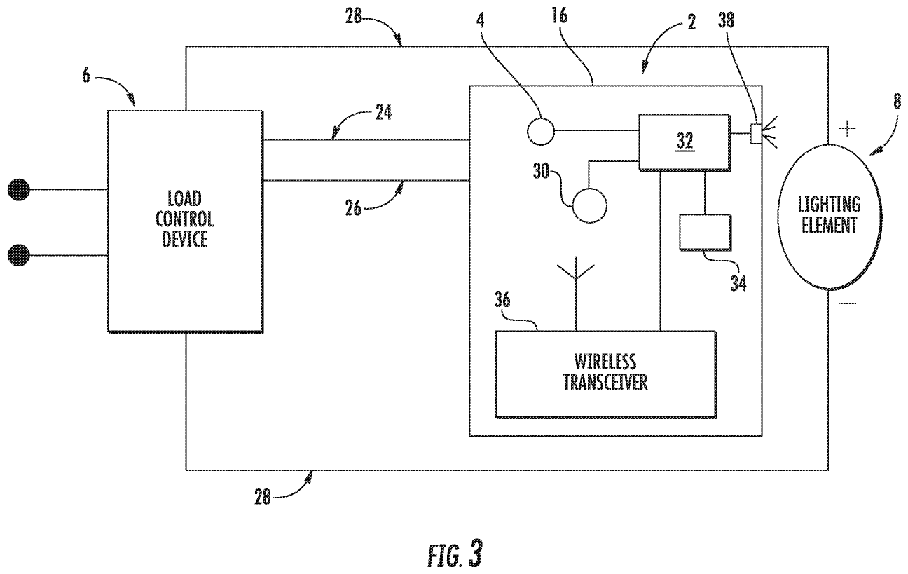

Referring now to FIG. 3, an embodiment of the lighting controller 2 integrated into the housing of the occupancy sensor 16 is shown. As shown, the lighting controller 2 is coupled to the load control device 6 via power and communications cables 24, 26 so that the load control device 6 can selectively provide power to components of the lighting controller 2 (via the power cable 24) and so that the lighting controller 2 can dictate operation of the load control device 6 (via the communications cable 26). Preferably, the lighting controller 2 may include a UART connection for messaging between the load controller 2 and the load control device 6. In the illustrated embodiment, the load control device 6 is coupled to the lighting element 8 via power lines 28. In non-limiting exemplary embodiments, the lighting controller 2 may instruct the load control device 6 to energize, de-energize, dim up or dim down the lighting element 8 via power lines 28. These instructions may be in response to an occupancy condition sensed by an occupancy sensing element 30, a change in light level sensed by the light sensor 4, a combination of both and/or some other signal/instruction received by the lighting controller 2.

The lighting controller 2 may further include a processor 32 for controlling operational aspects of the lighting controller and the components coupled thereto, and for commanding and decoding communication signals sent between the lighting controller 2 and the portable remote device 14 (FIG. 2). The processor 32 may include local memory 34 associated therewith for storing information including, but not limited to, configuration and operational information transmitted from the portable remote device 14. The memory 34 may be any of a variety of volatile or non-volatile memory types.

The lighting controller 2 may also include a wireless transceiver 36 for receiving wireless signals from the portable remote device 14. The wireless transceiver 36 may be coupled to the processor 34 to enable the processor 34 to use the received information from the portable remote device 14 to control one or more operational aspects of the lighting controller 2 or the components coupled thereto.

In some embodiments, the processor 32 can command the wireless transceiver 36 to transmit signals back to the portable remote device 14 or other device to provide operational, calibration and/or configuration information relating to the lighting controller 2. In one exemplary non-limiting embodiment, the transceiver 36 may be used to provide an acknowledgement signal to the portable remote device 14 once a configuration, calibration or other step is completed. Alternatively or in addition thereto, the lighting controller 2 may include a visual display 38, such as an LED, that provides a visual indication to a user when a configuration, calibration or other step is completed. It will be appreciated that although the wireless transceiver 36 is illustrated as a single element (i.e., chip), the wireless receiver and transmitter functionality may be provided as separate devices within the occupancy sensor 16.

In some embodiments, a user may review a list of available wireless networks on the portable remote device 14, and the name of the lighting controller 2 (or occupancy sensor 16) may appear in a screen list of available wireless options. To interface with a particular occupancy sensor, the user may simply select that sensor from the displayed list, and by entering a password may be connected to the occupancy sensor 16 and/or the lighting controller 2. The portable remote device 14 may couple to the wireless transceiver 36 of the lighting controller using any of a variety of suitable wireless transmission technologies including RF transmission using one of the many standards developed by the Institute of Electrical and Electronic Engineers (IEEE), infrared transmission using a standard from the Infrared Data Association (IrDA), or any other standardized and/or proprietary wireless communication technology. In non-limiting exemplary embodiments the wireless transmission technology used can be Wi-Fi, Bluetooth, Bluetooth Low Energy (BLE), ZigBee, Z-wave, near field communication (NFC), and the like.

The processor 32 may be communicatively coupled to all of the individual components of the lighting controller 2 to facilitate control of one or more operational aspects of lighting control system 1. When the wireless transceiver 36 is active, the lighting controller 2 may be visible to other wireless devices, such as the portable remote device 14, and may therefore be available for calibration via the portable remote device 14. Thus, in an active state, the wireless transceiver 36 can receive wireless signals from the portable remote device 14, and the processor 32 may take one or more actions based on the received wireless signals. Optionally, the status indicator 38 of the lighting controller 2 may be illuminated or may flash in a predetermined pattern when the wireless transceiver 36 is active.

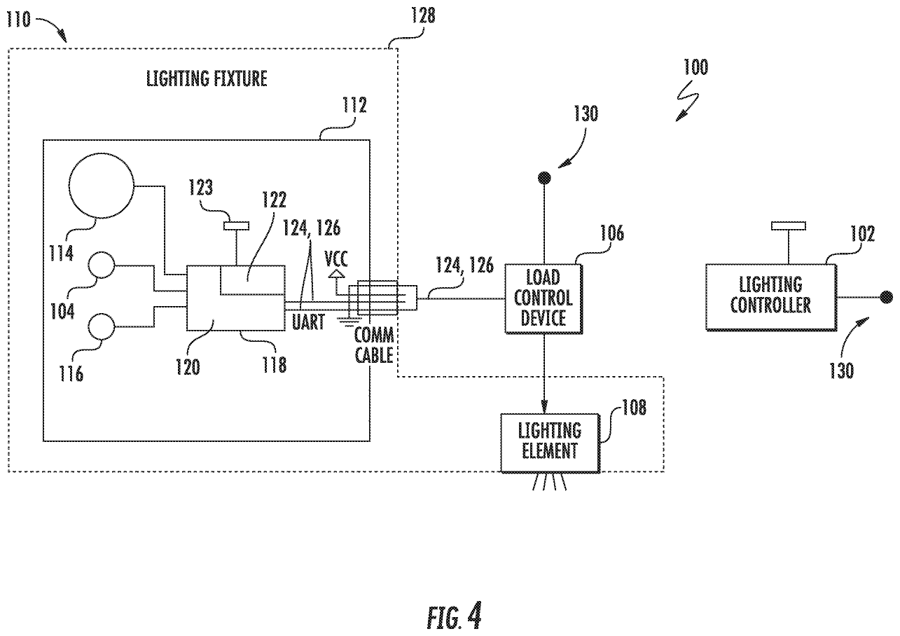

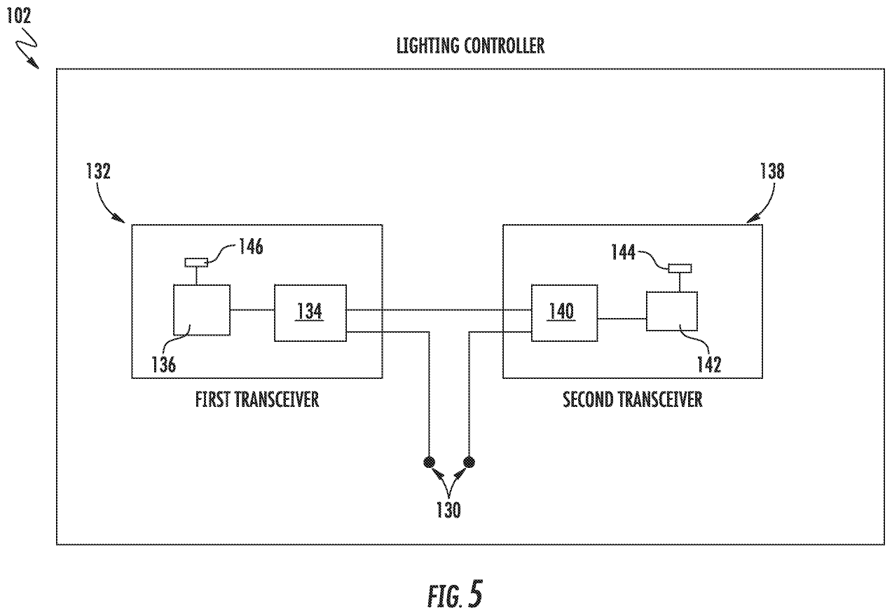

FIGS. 4 and 5 illustrate a second embodiment of a lighting control system 100 in which the lighting controller 102 is located remotely from the light sensor 104, the load control device 106 and the lighting element 108. In this embodiment, the lighting controller 102 may wirelessly communicate with both the portable remote device 14 (FIG. 1) and a lighting fixture 110 that houses the light sensor 104 and the lighting element 108. The lighting fixture 110 may include a wireless sensor and control module 112 communicatively coupled to the light sensor 104 and lighting element 108. The wireless sensor and control module 112 may also be coupled to the load control device 106 to control operation of the lighting element 108. In the illustrated embodiment the lighting controller 102, and may be positioned in the ceiling, in or on a wall, or at an entry station in the associated room. The sensor and control module 112 of the lighting fixture 110 may further include an occupancy sensing element 114, a status indicator 116 such as an LED, and a communications module 118 which may include a wireless communications module/chip. The communications module 118 may include a fixture processor 120 and a fixture transceiver 122.

The load control device 106 may be coupled to the sensor and control module 112 via one or more power and communications cables 124,126 so that the load control device 106 can supply power to the sensor and control module 112 (via the power cable) and so the sensor and control module 112 can command operation of the load control device 106 (via the communications cable). In some embodiments, the communication cable preferably is a simple universal asynchronous receiver/transmitter (UART) connection for messaging between the sensor and control module 112 and the load control device 106.

The load control device 106 may be coupled to the lighting element 108 and to a source of power (e.g., line power) 130 so that the lighting element 108 may be selectively illuminated in response to commands from the lighting controller 102.

The fixture transceiver 122 may be coupled to an antenna 123 and may use any of a variety of suitable wireless transmission technologies to communicate with the lighting controller 102 including RF transmission using one of the many standards developed by the Institute of Electrical and Electronic Engineers (IEEE), infrared transmission using a standard from the Infrared Data Association (IrDA), or any other standardized and/or proprietary wireless communication technology. In non-limiting exemplary embodiments the wireless transmission technology used can be Wi-Fi, Bluetooth, Bluetooth Low Energy (BLE), ZigBee, Z-wave, near field communication (NFC), and the like.

The fixture processor 120 may be communicatively coupled to each of the individual components of the sensor and control module 112 to control one or more operational aspects of the lighting control system 100. The fixture processor 120 also may receive and process incoming wireless messages from the lighting controller 102 via the fixture transceiver 122. In one particular embodiment, the fixture processor 120 is configured to: (i) receive ambient light level information from the light sensor 104; (ii) manage the transmission of ambient light level information to the lighting controller 102; (iii) receive messages from the lighting controller 102 instructing the fixture processor 120 to increase or decrease the amount of light provided by the lighting element 108; and (iv) transmit operational command signals to the load control device 106 to control the lighting element 108 (e.g., turn on/off and dim up/down).

The occupancy sensing element 114 may employ any of a variety of sensing technologies, including passive infrared (PIR), ultrasound (U/S) audio, video, microwave, and the like (or a combination thereof). The light sensor 104 may be a photocell or other appropriate light sensor. The lighting fixture 110 may be a troffer, a linear fixture, a pendant, a recessed fixture, a wall wash, or the like. As previously noted, the lighting element 108 may include at least one LED.

As shown in FIG. 5, and as previously described, the lighting controller 102 may include a first transceiver 132 for wirelessly communicating with the fixture transceiver 122 of the lighting fixture 108.

The first transceiver 132 may include a first processor 134, a first transceiver portion 136, and a first antenna 146. The first transceiver portion 136 may be communicatively coupled to the first processor 134. Though the first transceiver portion 136 and first processor 134 are shown and described as separate elements, they may be integrated, for example, on a single chip. Non-volatile memory may be associated with the first processor 134.

The lighting controller 102 may further include a second wireless transceiver 138 for wirelessly communicating with the portable remote device 14. In one non-limiting exemplary embodiment the second wireless transceiver may be a Wi-Fi transceiver, and the portable remote device may be a smartphone, smart tablet, laptop, or other computing device running a custom application (“App”) which can facilitate calibration and control of the lighting controller 102 and lighting fixture 110. The second transceiver 138 may include a second processor 140, and may have a second transceiver portion 142 with a second antenna 144 that is separate from the first antenna 146 of the first transceiver 132. Though the second transceiver portion 42 and the second processor 40 are shown and described as separate elements, they may be integrated, for example, on a single chip. Non-volatile (or other suitable) memory may be associated with the second processor 140.

The first and second processors 134, 140 may be coupled in a manner that enables them to intercommunicate with each other. A wired communication coupling is shown, but this is not limiting. As will be appreciated, such intercommunication can allow information to be passed through the lighting controller 102 in an efficient manner. For example, a user may employ the portable remote device 14 to wirelessly transmit information to the second transceiver 138 of the lighting controller 102 regarding a sensed lighting level at a work surface 12 (FIG. 1). The lighting controller 102, in turn, may send instructions from the first transceiver 132 to the fixture transceiver 122 that may cause the lighting element 108 to change amount of light provided.

In further embodiments, the lighting controller functionality may be included in the lighting fixture.

As previously noted, a user may employ the portable remote device 14 to calibrate a daylighting level for a light sensor used in systems, such as, but not limited to, the lighting control systems 1, 100 described in relation to FIGS. 2-5. In some embodiments, the portable remote device 14 may run a custom application (“App”) 22 (FIG. 2) that may include an appropriate interface for enabling the user to remotely calibrate the daylighting level to provide, for example, a selected lighting level at a work surface 12.

In one non-limiting exemplary embodiment, the App 22 may follow a set of connection and configuration/calibration screens, enabling a user to automatically adjust the amount of light provided by the lighting element 8, 108 to provide a desired lighting level at a particular work surface 12. The user may move from room to room, connecting to the lighting controller 2, 102 in that room, and can calibrate the lighting system 1, 100 in that room to obtain a desired lighting level at each work surface in each targeted room.

As will be appreciated, the App 22 may be loaded on the portable remote device 14 in a known manner, and may execute, using a processor of the portable remote device, a series of instructions on the device to receive inputs from the user, to obtain sensor information from one or more sensors of the device, to perform calculations based on the user inputs and the sensor information, and to send wireless signals to a lighting controller 2, 102 in order to calibrate a daylighting aspect of the lighting system 1, 100. Thus, the portable remote device 14 may include appropriate processing, storage, input/output functionality and wireless communications functionality to enable the user, via the App, to receive prompts and to input information into the portable remote device. For example, the App may cause the portable remote device 14 to display one or more lists of questions via a display portion, and user inputs may be received via a touch screen, keyboard, voice input or other input portion of the device. User prompts from the APP may be visual, audible, or combinations thereof.

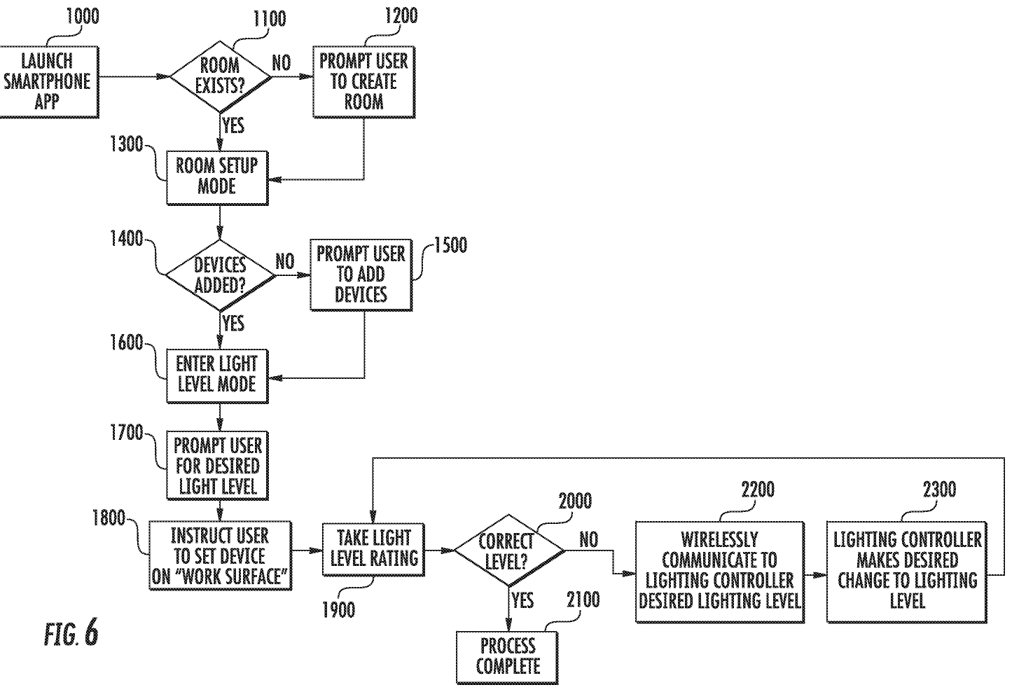

Referring now to FIG. 6, a flow diagram illustrating an exemplary method according to the present disclosure is illustrated. It will be appreciated that although the method will be described in relation to a single lighting element 8, 108 in a single room 10 with a single work surface 12 (FIG. 1), the method may be implemented with multiple lighting elements in multiple rooms, hallways or any section of floor space in a building that has multiple work surfaces. In addition, although the method will be described in relation to an App executing instructions on a portable remote device such as a smartphone, smart tablet, laptop or the like, it will be appreciated that the method is not limited to an App or to such devices.

At 1000, a user may launch an application (“App”) stored on a portable remote device 14 such as a smartphone, smart tablet, laptop or the like. The App may prompt the user to perform certain actions, including reviewing information on a display portion of the portable remote device and/or inputting information to the portable remote device via an input portion of the device. At 1100, the App may prompt the user to indicate whether a room (i.e., the room in which a lighting element and a work surface are disposed) has been “created” in the App. (It will be appreciated that although the method will be described in relation to a “room,” that the method is not so limited and can apply equally to instances in which a work surface is disposed in an area, hallway or any other section of floor space in a building.) If the user answers “no” to the inquiry, indicating that the room has not been “created,” then at 1200 the App may prompt the user to create the room by selecting a predetermined text name from a displayed list, or by inputting a new text and/or numerical name identifying the room to the user. Once the room is created, the method may proceed to a room setup mode at 1300. If, in response to the inquiry at 1100, the user answers “yes,” indicating that the room has already been “created,” then the user may select the room from a list, after which the method may proceed directly to the room setup mode at 1300.

At 1400, the App may prompt the user to indicate whether a device, such as a lighting controller, exists (or has already been added) in the selected room. If the user answers “no” to the inquiry, indicating that the device has not been “created,” then at 1500 the App may prompt the user to create the device by selecting a predetermined text and/or numerical name from a displayed list, or by inputting new text and/or numerical name identifying the device to the user. Once the device is created, the method may proceed to a light level mode at 1600. If, in response to the inquiry at 1400, the user answers “yes,” indicating that the device has already been “created” within the selected room, then the user may select the device from a list, after which the method may proceed directly to the light level mode at 1600.

At 1700, the App may prompt the user to input a desired light level for a work surface disposed in the room. For example, the App may prompt the user to select a desired light level value from a predetermined list of light levels to numerically enter a desired light level value, to set the desired light level to a current level, etc. In one non-limiting exemplary embodiment, the light level may be retrieved from a preferences file. For example, the light level could be retrieved automatically from settings for the user or building that have been previously entered, or the light level may be automatically or manually retrieved from cloud-based storage. Such arrangements may eliminate the need for the user to type or manually enter the value multiple times. The user-selected light level value may be inputted in Lux or foot candles, though it will be appreciated that other units and indications of light levels can also or alternatively be used. At 1800, the App may prompt the user to set the portable remote device 14 on the work surface 12 for which the light level is being calibrated. At 1900 the App may obtain a light level reading from a light sensor or other ambient light sensor associated with the portable remote device 14. In some embodiments, the light level reading may be obtained when the App determines that the portable remote device 14 has been positioned on the work surface 12. For example, the portable remote device 14 may include an accelerometer or other device that senses the position of the device and whether it is in motion. Thus, if the portable remote device 14 senses, from its internal accelerometer, that it is in a predetermined stationary position (e.g., face up on a surface) and/or has remained “still” for a predetermined time, it may automatically obtain the light level reading. In other embodiments, a timer may be set after the prompt is provided, upon the expiration of which a light level reading is obtained. Alternatively, a second prompt may be provided to the user to press a soft key or provide another input to the portable remote device 14 to confirm that the device 14 has been placed on the work surface 12.

At 2000 the App may compare the sensed light level obtained from the portable remote device 14 to the user-selected light level obtained at step 1700. If the sensed light level is determined to be different from the user-selected light level by less than a predetermined amount, then at 2100 the App causes the portable remote device 14 to send a wireless signal to the lighting controller 2, 102 indicating that the amount of light provided by the lighting element 8, 108 is calibrated to the user-selected lighting level at the work surface 12. If, however, the sensed light level is determined to be different from the user-selected light level by more than the predetermined amount, then at 2200 the App causes the portable remote device 14 to send a wireless signal to the lighting controller 2, 102 instructing the lighting controller 2, 102, at 2300, to take a particular action. For example, the lighting controller 2, 102 may receive the wireless signal and in response may increase or decrease the amount of light provided by the lighting element 8, 108, by an incremental amount. In one non-limiting exemplary embodiment, the incremental amount may be a percentage, a non-limiting example of which may be 10% of the current amount of provided light. In other embodiments, the incremental amount may be a set number, or user-selected number, of Lux, a non-limiting example of which may be 10 Lux or equivalent foot candles. For example, if the sensed light level is determined by the App to be lower from the user-selected light level by more than the predetermined amount, the wireless signal may cause the lighting controller 2, 102 to increase the amount of light provided by the lighting element 8, 108 by the incremental amount. Alternatively, if the sensed light level is determined by the App to be higher than the user-selected light level by more than the predetermined amount, the wireless signal may cause the lighting controller 2, 102 to decrease the amount of light provided by the lighting element 8, 108 by the incremental amount.

In some embodiments, the predetermined amount may be selected by the user before, during or after the step in which the user selects a desired light level (step 1700). In other embodiments, the predetermined amount may be a percentage value, a non-limiting example of which may be 10% of the current amount of light provided, or it may be a set value, a non-limiting example of which may be 5 Lux or equivalent foot candles. In some embodiments the predetermined amount may be retrieved from a preferences file. For example, the predetermined amount could be retrieved automatically from settings for the user or building that have been previously entered, or the predetermined amount may be automatically or manually retrieved from cloud-based storage. Such arrangements may eliminate the need for the user to type or manually enter the value multiple times.

Once the lighting controller 2, 102 has adjusted the amount of light provided by the lighting element 8, 108, the method may return to step 1900 where the App may obtain a new light level reading from the light sensor of the portable remote device 14, and may, at 2000, compare the new sensed light level to the user-selected light level. If the new sensed light level is determined to be different from the user-selected light level by less than a predetermined amount, then at 2100 the App may cause the portable remote device 14 to send a wireless signal to the lighting controller 2, 102 indicating that the amount of light provided by the lighting element 8, 108 is calibrated to the user-selected lighting level at the work surface 12. If, however, the new sensed light level is determined to be different from the user-selected light level by more than the predetermined amount, then at 2200 the App may cause the portable remote device 14 to send another wireless signal to the lighting controller 2, 102 causing the lighting controller 2, 102, at 2300, to increase or decrease the amount of light provided by the lighting element 8, 108 by an incremental amount. The App may then make a further determination and comparison of sensed light level to user-selected light level at 1900-2000, and the process may repeat, as many times as necessary, until the difference between the sensed light level and the user-selected light level is less than the predetermined amount.

As mentioned, when the App determines that the difference between the sensed light level and the user-selected light level is less than the predetermined amount, it may assume that the amount of light provided by the lighting element 8, 108 corresponds to a desired lighting level at the work surface 12. As a result, the App may cause the portable remote device 14 to send an appropriate wireless signal to the lighting controller 2, 102 indicating such. In response, the lighting controller 2, 102 may obtain a lighting level from a connected light sensor 4, 104 and set the obtained light level as a daylighting level for the light sensor 4, 104.

Once the daylighting level for the light sensor 4, 104 is set, the lighting controller 2, 102 may control the amount of light provided by the lighting element 8, 108 so that the light level sensed by the light sensor 4, 104 remains within a predetermined band (e.g., +/−300 Lux or equivalent foot candles). By adjusting the amount of light provided by the lighting element 8, 108 to ensure the light level sensed by the light sensor 4, 104 remains within this predetermined band, it can reasonably be assumed that the lighting level at the work surface 12 will remain within a similar band with respect to the user-selected light level.

By periodically sampling the light level sensed by the light sensor 4, 104 the lighting system can adjust to, and compensate for, changes in ambient light contribution that may naturally occur throughout the day. Thus, as ambient light contribution increases, the amount of light provided by the lighting element 8, 108 may automatically and correspondingly decrease to maintain the lighting level at the work surface 12 at or near the user-selected lighting level. Similarly, as ambient light contribution decreases, the amount of light provided by the lighting element 8, 108 may automatically and correspondingly increase to maintain the lighting level at the work surface 12 at or near the user-selected lighting level.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision additional modifications, features, and advantages within the scope and spirit of the claims appended hereto.

1. A calibration and daylighting control system for providing a predetermined lighting level at a work surface, comprising:
a light sensor for detecting a light level in an associated area;
a lighting element for providing an amount of light to the associated area and the work surface located within the associated area;
a load control device for controlling the amount of light provided by the lighting element;
a wireless transceiver for wireless communication with a portable remote device; and
a processor coupled to the light sensor, the load control device and the wireless transceiver, wherein the processor is programmed to:
receive, via the wireless transceiver, wireless signals from the portable remote device; and
set a daylighting level of the light sensor based on the received wireless signals;
wherein the received wireless signals are indicative that the daylighting level of the light sensor corresponds within a predetermined amount to a user-selected lighting level at the work surface.

2. The system of claim 1, wherein the processor is programmed to adjust the amount of light provided by the lighting element based on the user-selected lighting level and a light level sensed by the light sensor.

3. The system of claim 2, wherein the processor is programmed to increase the amount of light provided by the lighting element when the received wireless signals indicate that a light level sensed by the portable remote device at the work surface is lower than the user-selected lighting level by more than a predetermined amount.

4. The system of claim 2, wherein the processor is programmed to decrease the amount of light provided by the lighting element when the received wireless signals indicate that a light level sensed by the portable remote device at the work surface is greater than the user-selected lighting level by more than a predetermined amount.

5. The system of claim 1, wherein the portable remote device is one of a smartphone, a smart tablet or a laptop, and wherein the user selected lighting level is input to the portable remote device via an application executable on the portable remote device.

6. The system of claim 1, wherein after the daylighting level of the light sensor is set, the processor is programmed to adjust the amount of light provided by the lighting element so that a lighting level sensed by the light sensor deviates from the set daylighting level by less than a predetermined amount.

7. A method for calibrating and controlling a lighting system to provide a predetermined lighting level at a work surface, the method comprising:
executing an application on a portable remote device, the application causing the portable remote device to:
receive a user input identifying a user-selected light level value;
obtain a sensed light level value from a light sensor of the portable remote device;
comparing the user-selected light level value to the sensed light level value; and
sending a wireless signal to a lighting controller; and
receiving, at the lighting controller, the wireless signal from the portable remote device;
wherein the wireless signal includes information representative of the comparison of the user-selected light level value to the sensed light level value.

8. The method of claim 7, wherein when the information representative of the comparison indicates that the sensed light level value is different from the user-selected light level value by more than a predetermined amount, the lighting controller adjusts an amount of light provided by a lighting element providing light to the work surface.

9. The method of claim 8, wherein when the information representative of the comparison indicates that the sensed light level value is less than the user-selected light level value by more than the predetermined amount, the lighting controller increases the amount of light provided by the lighting element by an incremental amount.

10. The method of claim 8, wherein when the information representative of the comparison indicates that the sensed light level value is greater than the user-selected light level value by more than the predetermined amount, the lighting controller decreases the amount of light provided by the lighting element by an incremental amount.

11. The method of claim 8, wherein after the lighting controller adjusts the amount of light provided by the lighting element, the portable remote device compares a new sensed light level value to the user-selected light level and sends a new wireless signal to the lighting controller, the new wireless signal including information representative of the comparison of the user-selected light level value to the new sensed light level.

12. The method of claim 8, wherein when the information representative of the comparison indicates that the sensed light level value is different from the user-selected light level value by less than the predetermined amount, the lighting controller sets a daylighting level of a light sensor of the lighting system.

13. The method of claim 12, further comprising controlling the amount of light provided by the lighting element so that the lighting level sensed by the light sensor deviates from the set daylighting level by less than the predetermined amount.

14. The method of claim 13, wherein controlling the amount of light provided by the lighting element results in the lighting level at the work surface deviating from the user-selected lighting level by less than the predetermined amount.

15. The method of claim 7, wherein the portable remote device is one of a smartphone, a smart tablet or a laptop.
